(19) United States
(12) Patent Application Publication
(10) Pub. No.: US 2014/0132742 A1
(43) Pub. Date: May 15, 2014

(54) Three-Dimensional Stereo Display Device and Method

(71) Applicant: NOVATEK MICROELECTRONICS CORP., Hsin-Chu (TW)

(72) Inventors: Guangzhi Liu, Shanghai (CN); Jiande Jiang, Xi'an (CN)

(73) Assignee: NOVATEK MICROELECTRONICS CORP., Hsin-Chu (TW)

(21) Appl. No.: 13/778,082

(22) Filed: Feb. 26, 2013

(30) Foreign Application Priority Data
Nov. 13, 2012 (CN) 201210453462.X

(51) Int. Cl. H04N 13/04

(52) U.S. Cl. CPC H04N 13/04
USPC 348/51

(57) ABSTRACT

A method is disclosed for display images on a three-dimensional stereo display device includes generating a detection result according to user information, and generating a disparity range signal according to the detection signal, a display information and a comfort model, retrieving a dense disparity map signal of an original display signal. The method also includes generating an adjusted disparity map signal according to the disparity range signal and the dense disparity map signal and outputting an adjusted display signal according to the adjusted disparity map signal and the original display signal, to process a three-dimensional stereo display operation of the three-dimensional stereo display device.

### BACKGROUND OF THE INVENTION

1. Field of the Invention

The present invention relates to a three-dimensional stereo display device and method, and more particularly, to a three-dimensional stereo display device and method which adjusts an output signal according to a comfort model and user information.

2. Description of the Prior Art

With the advancement of imaging technologies, consumers have great varieties of sizes and functions of display devices to choose from. In order to comply with different user's requirements, display device suppliers provide more products equipping with better output efficiency as well as higher display resolution, and one of the most popular types of research has been focused on how to apply the three-dimensional stereo display technology of movie scenes on family small-sized display devices.

The general three-dimensional stereo display technology is based on the human visual system principle, which means that the right eye and the left eye are utilized to display different disparity imaging information, and can be categorized into the polarized display process, the interlaced display process or the anaglyph display process. While making a three-dimensional movie, two or more cameras with different depth parameters are utilized for displaying different profiles and providing stereo imaging entertainment. However, it is difficult to demonstrate the same stereo movie scenes on the general small-sized display devices because the movie shooting process is correspondingly designed to match the size of the movie theater. Though other imaging post-processing may be applied to adjust the stereo movie scenes displayed on the general small-sized display devices, the related resolution could be sacrificed such that the observers are dazzled by the adjusted stereo movie scenes. Therefore, it has been an important issue to provide another three-dimensional stereo display device and method which adjust an output signal according to a comfort model and user information.

### SUMMARY OF THE INVENTION

A three-dimensional stereo display device and method is provided to adjust an output signal according to a comfort model and user information.

According to an aspect of the disclosure, a method is provided for display images on a three-dimensional stereo display device. The method comprises generating a detection result according to user information; generating a disparity range signal according to the detection signal, a display information and a comfort model; retrieving a dense disparity map signal of an original display signal; generating an adjusted disparity map signal according to the disparity range signal and the dense disparity map signal; and outputting an adjusted display signal according to the adjusted disparity map signal and the original display signal, to process a three-dimensional stereo display operation of the three-dimensional stereo display device.

According to an aspect of the disclosure, a three-dimensional stereo display device is provided to comprise a detection module, for generating a detection result according to user information; a determination module, for generating a disparity range signal according to the detection signal, a display information and a comfort model; a reception module, for retrieving a dense disparity map signal of an original display signal; an adjustment module, for generating an adjusted disparity map signal according to the disparity range signal and the dense disparity map signal; and an output module, for outputting an adjusted display signal according to the adjusted disparity map signal and the original display signal, to process a three-dimensional stereo display operation of the three-dimensional stereo display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a three-dimensional stereo display device according to an embodiment of the invention.

FIG. 2 illustrates a schematic diagram of the three-dimensional stereo display device and a user according to an embodiment of the invention.

FIG. 3 illustrates a comfort model according to an embodiment of the invention.

FIG. 4 illustrates a schematic diagram of an average dense disparity signal according to an embodiment of the invention.

FIG. 5 illustrates a flow chart of a three-dimensional stereo display process according to an embodiment of the invention.

### DETAILED DESCRIPTION

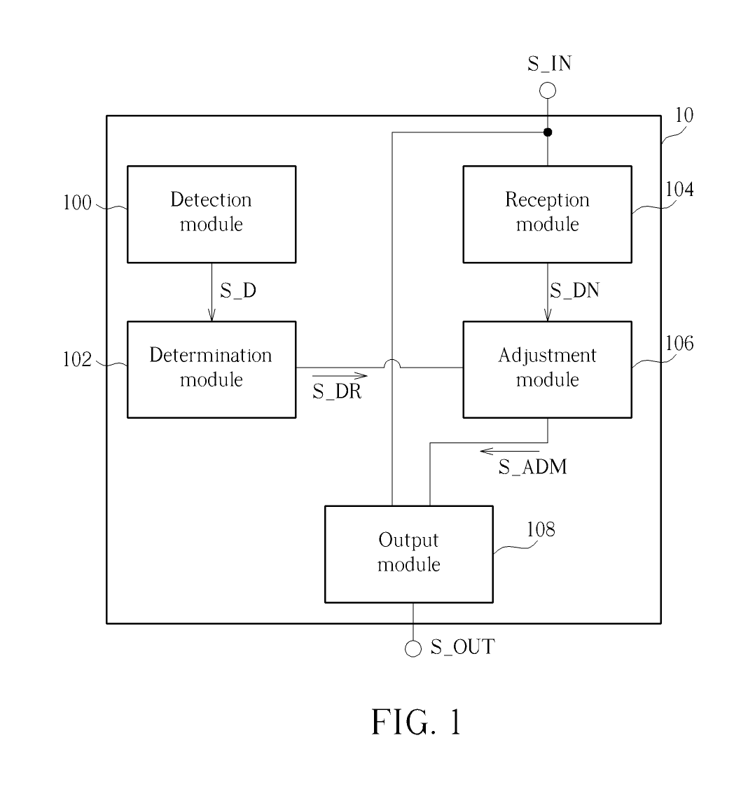

Please refer to FIG. 1, which illustrates a three-dimensional stereo display device 10 according to an embodiment of the invention. Internal structures of the three-dimensional stereo display device 10 are simply demonstrated, and other display elements, such as a light guide plate, a light generation module or a display panel, may be included as well, which is not meant to limit the scope of the invention. As shown in FIG. 1, the three-dimensional stereo display device 10 comprises a detection module 100, a determination module 102, a reception module 104, an adjustment module 106 and an output module 108. Preferably, the three-dimensional stereo display device 10 of the invention can practically display the stereo movie scenes, which are displayed in the movie theater, on the small-sized display device, and it is not necessary to sacrifice the original imaging resolution of the stereo movie scenes, such that the observers are not easily dazzled by the adjusted stereo movie scenes after long term viewing.

In detail, the detection module 100 is an imaging detection module, such as a camera module, to detect an observation distance V between a user (not shown in the figure) and the three-dimensional stereo display device 10, and a two-eyes distance D is detected by the detection module 100 as well, to generate a detection result S_D to be transmitted the determination module 102. Certainly, the detection module 100 can alternatively utilize a face/eye tracking technology to simultaneously obtain the detection result S_D, i.e. the observation distance V and the two-eyes distance D, which is also in the scope of the invention. Besides, disposition of the detection module 100 should be well known to those skilled in the art, and can be adaptively designed to match the external designs of the three-dimensional stereo display device 10, such that the detection module 100 may be disposed inside or outside one side of the three-dimensional stereo display device 10, which is not meant to limit the scope of the invention.

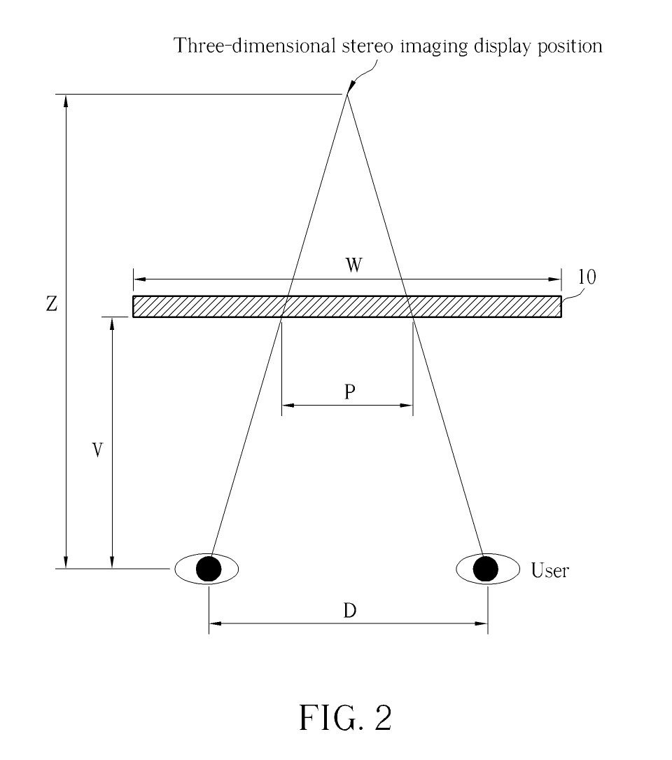

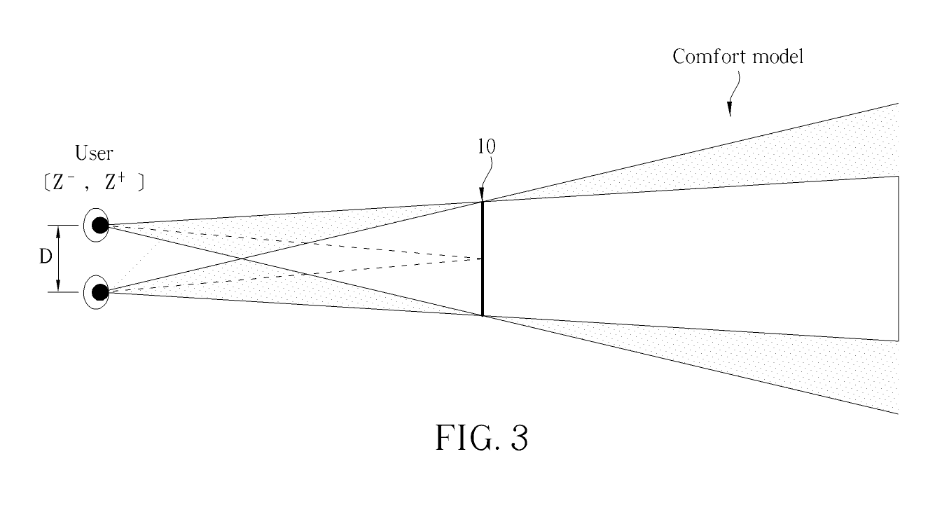

The determination module 102 is utilized to receive the detection result S_D, and also predetermines or receives a display device information and a comfort mode. Please refer to FIG. 2, which illustrates a schematic diagram of the three-dimensional stereo display device 10 and a user according to an embodiment of the invention. As shown in FIG. 2, the display device information represents the basic information related to the three-dimensional stereo display device 10, such as a display range W, a display disparity P, a resolution R and a relative distance Z between the user and a three-dimensional stereo imaging display position. The three-dimensional stereo display device 10 further comprises a plurality of pixel units, wherein each of the plurality of pixel units comprises a pixel unit disparity p. Please refer to FIG. 3, which illustrates a comfort model according to an embodiment of the invention. As shown in FIG. 3, the comfort model is a Panum area model, and is not meant to limit the scope of the invention. Based on an observational angel from the two eyes of the user extending to the display panel, a proper observational distance between the user and the three-dimensional stereo display device 10 can be obtained to provide a three-dimensional stereo imaging for the user in the long term observation without feeling dazzled and preventing the user from having exhausted vision. In the embodiment, the comfort model provides the observational distance as [Z⁻,Z⁺], and accordingly, the observational distance as [Z⁻,Z⁺] is inputted into the formula

$$p = \frac{P \times R}{W} = \frac{D \times ( Z - V ) \times R}{W \times Z}$$

to obtain a lower/upper boundary of the pixel unit disparity as [p³¹ ,p⁺]. Thus, the determination module 102 generates a disparity range signal S_DR (i.e. the lower/upper boundary of the pixel unit disparity as [p⁻,p⁺]) to the adjustment module 106 according to the related parameters of the detection result S_D, the display device information and the comfort model.

The reception module 104 receives an original display signal S_IN via a wireless/wired transmission operation, such as a TV program display signal, and preferably, the original display signal S_IN of the invention is an original three-dimensional stereo display imaging including a plurality of sub original display signals, so as to match the plurality of pixel units of the display panel. Besides, the reception module 104 further utilizes a stereo matching technology to retrieve a dense disparity map signal S_DM of the original display signal S_IN, wherein the dense disparity map signal S_DM comprises a plurality of dense disparity signals to correspond to the plurality of sub original display signal of the original display signal S_IN, so as to represent a disparity condition Pᵢₙ of the original display signal S_IN in the three-dimensional stereo display technology. Accordingly, the dense disparity map signal S_DM is outputted to the adjustment module 106.

The adjustment module 106 receives the disparity range signal S_DR (i.e. the lower/upper boundary of the pixel unit disparity as [p⁻,p⁺]) and the dense disparity map signal S_DM, and accordingly, outputs an adjusted disparity map signal S_ADM to the output module 108. In the embodiment, a maximum dense disparity signal Pₘₐₓ and a minimum dense disparity signal Pₘᵢₙ can be correspondingly retrieved from the lower/upper boundary of the pixel unit disparity as [p⁻,p⁺]. Also, the pixel unit number N of the display panel in the three-dimensional stereo display device 10 and the disparity condition Pᵢₙ corresponding to each of the pixel units are utilized for inputting into the formula

$$τ = \frac{\sum {P}_{i n}}{N} ,$$

to correspondingly obtain an average dense disparity signal τ. Certainly, it is possible to arrange all the disparity conditions of the plurality of pixel units, so as to choose a median from the plurality of disparity conditions as another median dense disparity signal, which is also in the scope of the invention. Therefore, the adjusted disparity map signal S_ADM is obtained via inputting the lower/upper boundary of the pixel unit disparity as [p^{—},p⁺], the average dense disparity signal τ, the maximum dense disparity signal Pₘₐₓ and the minimum dense disparity signal Pₘᵢₙ into the formula

$${P}_{out} = ( {p}^{+} - {p}^{-} ) \times \frac{ln ( {P}_{i n} + τ ) - ln ( {P}_{m i n} + τ )}{ln ( {P}_{ma x} + τ ) - ln ( {P}_{m i n} + τ )} + {p}^{-}$$

to obtain Pₒᵤₜ, where Pₒᵤₜ represents the adjusted disparity map signal S_ADM.

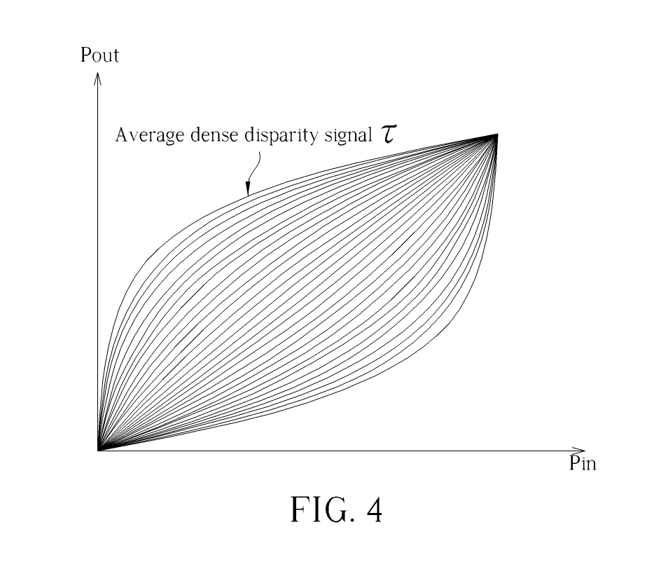

Please refer to FIG. 4, which illustrates a schematic diagram of an average dense disparity signal τ according to an embodiment of the invention. As shown in FIG. 4, based on the disparity condition of each of the pixel units and the average dense disparity signal selected by the user, a relationship profile is obtained related to the adjusted disparity map signal S_ADM (i.e. Pₒᵤₜ) and the plurality of inputted disparity conditions, such that a look-up table can be obtained according to the relationship profile. Thus, the adjustment module 106 can pre-store the look-up table to correspondingly output the adjusted disparity map signal S_ADM to the output module 108 according to the dense disparity map signal S_DM and the lower/upper boundary of the pixel unit disparity as [p⁻,p⁺], which provides the convenient solution to avoid burdensome calculation processes and is not meant to limit the scope of the invention.

Lastly, the output module 108 receives the original display signal S_IN and the adjusted disparity map signal S_ADM to generate an adjusted display signal S_OUT, such that the three-dimensional stereo display device 10 can process a three-dimensional stereo display operation. In the embodiment, the output module 108 utilizes a depth image based rendering (DIBR) to transform the original display signal S_IN into the adjusted display signal S_OUT. The DIBR further processes a noise eliminating procedure, a 3D image warping procedure and a hole filling procedure, to output a smooth and genuine three-dimensional stereo imaging on the display panel. Certainly, those skilled in the art can further combine other imaging processes with the embodiment of the invention to adjust a color saturation parameter or a frame rate parameter of the three-dimensional stereo imaging, which is also in the scope of the invention.

Simply, the three-dimensional stereo display device 10 of the invention receives the original display signal S_IN, and then the user information (i.e. the information related to the viewer observing the three-dimensional stereo display device 10) and the dense disparity map signal S_DM of the original display signal S_IN are obtained. Next, the determination module 102 generates the disparity range signal S_DR and the adjustment module 106 generates the adjusted disparity map signal S_ADM, such that the output module 108 correspondingly outputs the adjusted display signal S_OUT to make the three-dimensional stereo display device 10 process the three-dimensional stereo display operation and make the user comfortably enjoy the three-dimensional stereo imaging as being in the movie theater. Under such circumstance, the embodiment of the invention can adaptively adjust the inputted three-dimensional stereo imaging signal according to related positions of the user and the display panel. Though FIG. 1 demonstrates the isolated block diagrams of the determination module 102, the adjustment module 106 and the output module 108 for clearly explaining operational mechanisms thereof, those skilled in the art can alternatively integrate the determination module 102, the adjustment module 106 and the output module 108 as another processing module. Under such circumstances, after the three-dimensional stereo display device 10 receives the original display signal S_IN, the related operations of the determination module 102, the adjustment module 106 and the output module 108 can be processed according to the detection result S_D of the user. Consequently, the processing module outputs the adjusted display signal S_OUT as well, which is also in the scope of the invention.

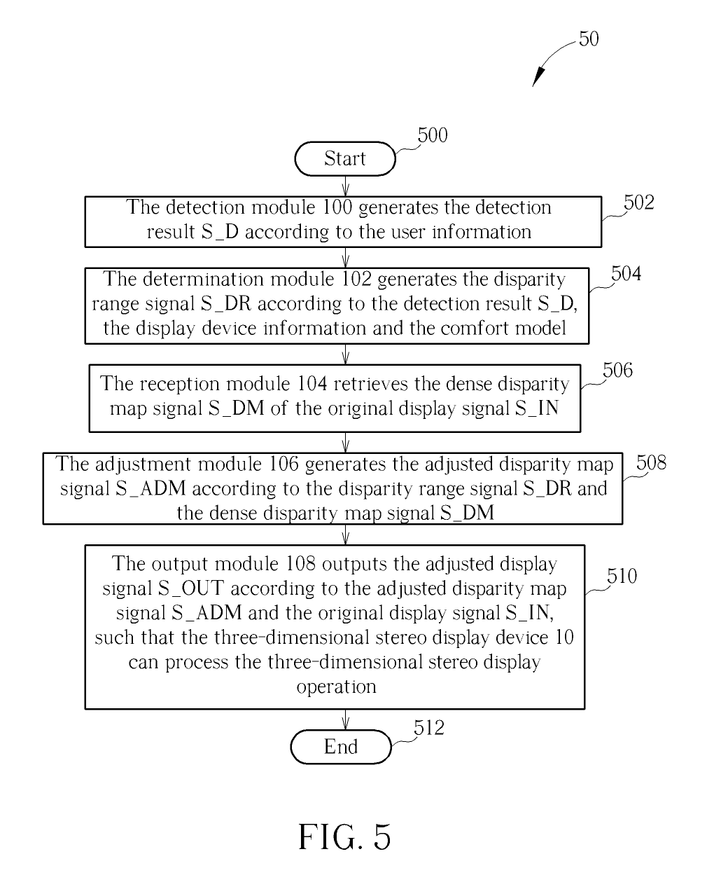

In the embodiment, a display operation method of the three-dimensional stereo display device 10 can be summarized as a three-dimensional stereo display process 50, as shown in FIG. 5. The three-dimensional stereo display process 50 includes the following steps:

Step 500: Start.

Step 502: The detection module 100 generates the detection result S_D according to the user information.

Step 504: The determination module 102 generates the disparity range signal S_DR according to the detection result S_D, the display device information and the comfort model.

Step 506: The reception module 104 retrieves the dense disparity map signal S_DM of the original display signal S_IN.

Step 508: The adjustment module 106 generates the adjusted disparity map signal S_ADM according to the disparity range signal S_DR and the dense disparity map signal S_DM.

Step 510: The output module 108 outputs the adjusted display signal S_OUT according to the adjusted disparity map signal S_ADM and the original display signal S_IN, such that the three-dimensional stereo display device 10 can process the three-dimensional stereo display operation.

Step 512: End.

Detailed operations of each of the steps in the three-dimensional stereo display process 50 can be understood via the embodiments depicted from FIG. 1 to FIG. 4 and related paragraphs thereof, and are not repeated here for brevity. Preferably, sequential orders of step 502 to step 506 can be adjusted according to different practical requirements. For example, after initiating the three-dimensional stereo display device 10, step 506 can be alternatively processed as another initiation step of the three-dimensional stereo display process 50, to determine whether the three-dimensional stereo display device 10 is necessary for the three-dimensional stereo display operation. Accordingly, step 502, step 504 and step 508 are sequentially processed if the three-dimensional stereo display operation is necessary. Furthermore, the three-dimensional stereo display operation of the embodiment can be integrated with other imaging processing mechanism procedures to provide the user viewing with the naked eye with the three-dimensional stereo imaging as in the movie theater. In the meanwhile, according to different observational conditions, an initial correction operation can be automatically operated while the user first initiates the three-dimensional stereo display device 10. Or a user input interface can also be utilized to provide a plurality of comfort models and a plurality of sentimental modules, which are predetermined in the three-dimensional stereo display device 10, so as to be randomly chosen by the user, which is also in the scope of the invention.

In summary, embodiments of the invention provide a three-dimensional stereo display device and method thereof, which output an adjusted output signal according to a comfort model and user information, to process a three-dimensional stereo display operation. In comparison, in the prior art it is difficult to display the complete stereo imaging as in the movie theater or it is necessary to sacrifice partial imaging resolution. However, the embodiments of the invention not only maintain the original imaging resolution to be displayed on the general small-sized display devices, but also reduce the possibility of feeling dazzled or causing exhausted vision after observing the three-dimensional stereo imaging for a long time, which can practically expand the product application of the three-dimensional stereo display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method for displaying images on a three-dimensional stereo display device, the method comprising:
generating a detection result according to user information;
generating a disparity range signal according to the detection signal, a display information and a comfort model;
retrieving a dense disparity map signal of an original display signal;
generating an adjusted disparity map signal according to the disparity range signal and the dense disparity map signal; and
outputting an adjusted display signal according to the adjusted disparity map signal and the original display signal, to process a three-dimensional stereo display operation of the three-dimensional stereo display device.

2. The method of claim 1, wherein the step of generating the detection result according to the user information further comprises:
detecting an observation distance between the user and the three-dimensional stereo display device;
detecting a two-eyes distance; and
generating the detection result according to the observation distance and the two-eyes distance.

3. The method of claim 1, wherein the display information comprises a resolution, a display range, a display disparity, a pixel unit disparity and a relative display distance.

4. The method of claim 1, wherein the comfort model is the Panum area model.

5. The method of claim 1, wherein the step of retrieving the dense disparity map signal of the original display signal further comprises:
utilizing a stereo matching technology to retrieve the dense disparity map signal of the original display signal.

6. The method of claim 5, wherein the dense disparity map signal comprises a plurality of dense disparity signals, and the original display signal comprises a plurality of sub original display signals corresponding to a plurality of pixel units of the three-dimensional stereo display device.

7. The method of claim 6, further comprising utilizing the stereo matching technology to retrieve the plurality of the dense disparity signals corresponding to the plurality of sub original display signals, wherein the plurality of dense disparity signals comprises a maximum dense disparity signal and a minimum dense disparity signal.

8. The method of claim 7, wherein the step of generating the adjusted disparity map signal according to the disparity range signal and the dense disparity map signal further comprises:
obtaining an average dense disparity signal according to the plurality of dense disparity signals; and
generating the adjusted disparity map signal according to the average dense disparity signal, the maximum dense disparity signal, the minimum dense disparity signal and the disparity range signal.

9. The method of claim 1, wherein the step of outputting the adjusted display signal according to the adjusted disparity map signal and the original display signal, to process the three-dimensional stereo display operation of the three-dimensional stereo display device further comprises:
utilizing a depth image based rendering (DIBR) technology and the adjusted disparity map signal to transform the original display signal into the adjusted display signal, so as to make the three-dimensional stereo display device display the adjusted display signal and process the three-dimensional stereo display operation.

10. A three-dimensional stereo display device comprising:
a detection module, for generating a detection result according to user information;
a determination module, for generating a disparity range signal according to the detection signal, a display information and a comfort model;
a reception module, for retrieving a dense disparity map signal of an original display signal;
an adjustment module, for generating an adjusted disparity map signal according to the disparity range signal and the dense disparity map signal; and
an output module, for outputting an adjusted display signal according to the adjusted disparity map signal and the original display signal, to process a three-dimensional stereo display operation of the three-dimensional stereo display device.

11. The three-dimensional stereo display device of claim 10, wherein the detection module further detects an observation distance between the user and the three-dimensional stereo display device and a two-eyes distance of the user, to generate the detection result.

12. The three-dimensional stereo display device of claim 10, wherein the display information comprises a resolution, a display range, a display disparity, a pixel unit disparity and a relative display distance.

13. The three-dimensional stereo display device of claim 10, wherein the comfort model is the Panum area model.

14. The three-dimensional stereo display device of claim 10, wherein the reception module further utilizes a stereo matching technology to retrieve the dense disparity map signal of the original display signal.

15. The three-dimensional stereo display device of claim 14, wherein the dense disparity map signal comprises a plurality of dense disparity signals, and the original display signal comprises a plurality of sub original display signals corresponding to a plurality of pixel units of the three-dimensional stereo display device.

16. The three-dimensional stereo display device of claim 15, wherein the reception module further utilizes the stereo matching technology to retrieve the plurality of the dense disparity signals corresponding to the plurality of sub original display signals, and the plurality of dense disparity signals comprises a maximum dense disparity signal and a minimum dense disparity signal.

17. The three-dimensional stereo display device of claim 16, wherein the adjustment module further obtains an average dense disparity signal according to the plurality of dense disparity signals, and generates the adjusted disparity map signal according to the average dense disparity signal, the maximum dense disparity signal, the minimum dense disparity signal and the disparity range signal.

18. The three-dimensional stereo display device of claim 10, wherein the output module further utilizes a depth image based rendering (DIBR) technology and the adjusted disparity map signal to transform the original display signal into the adjusted display signal, so as to make the three-dimensional stereo display device display the adjusted display signal and process the three-dimensional stereo display operation.
